(19) United States
(12) Patent Application Publication
(10) Pub. No.: US 2002/0156730 A1
(43) Pub. Date: Oct. 24, 2002

(54) Method of managing billing information at a well site

(76) Inventor: Frederic M. Newman, Midland, TX (US)

Correspondence Address: ROBERT J. HARTER, 4233 CLIFFSIDE DRIVE, LA CROSSE, WI, 54601, US

(21) Appl. No.: 09/839,103

(22) Filed: Apr. 23, 2001

(51) Int. Cl. G06F 17/60

(52) U.S. Cl. 705/40; 705/39

(57) ABSTRACT

A method of managing invoices for goods services provided by several contractors working at a remote well site involves entering invoice data into a mobile computer at the well site and transmitting the data over a wireless communication link to a home base computer. In some forms of the invention, the invoice data is validated by transducer-generated data, which is produced by a transducer that senses a service operation (e.g., replacing sucker rods) being performed at the well site. Passwords prevent unauthorized use. Some information displayed on the computer at the well site reassures the contractors that the computers are communicating. The method is particularly useful when the contactors are independent contractors using different service vehicles in performing significantly different service operations.

### BACKGROUND OF THE INVENTION

1. Field of the Invention

The invention generally pertains to managing billing information and more specifically to managing billing information of more than one contractor at a well site.

2. Description of Related Art

After a well is set up and operating to draw petroleum, water or other fluid up from within the ground, various replacement parts and services are periodically provided to maintain the well. Such parts and services may include replacing worn parts such as a pump, sucker rods, inner tubing, and packer glands; pumping chemical treatments or hot oil down into the well bore; and pumping cement into the well bore to partially close off a portion of the well (or to shut it down entirely). Since wells are often miles apart from each other, the maintenance or service operations are usually performed by a mobile unit or service vehicle having special onboard servicing equipment suited to perform the work. Some examples of service vehicles include a chemical tank truck or trailer, a cement truck or trailer, a hot-oiler tank truck or trailer, and a portable work-over service rig having a hoist to remove and install well components (e.g., sucker rods, tubing, etc.).

Service vehicles are often owned by an independent contractor that the well company (e.g., well owner or operator) hires to service the wells. Typically, the contractor performs the work and later mails the well company an invoice. However, before paying the invoice, the well company may want to confirm that they have actually received the products or services for which they are being billed. Unfortunately, acquiring such confirmation can be difficult, time consuming, and perhaps even impossible in some cases.

For example, it may be difficult for a well company to determine whether a pump has actually been replaced after the pump has already been installed at the bottom of the well bore. Or, if the well company had no representative at the well site to witness a chemical treatment being applied to the well, it may be difficult or impossible to later determine the chemical's quantity or its concentration. Even if a company witness were present to observe the performance of a service or delivery of a product, payment of the invoice may still be delayed until after the company's accounting department discusses the invoice with the witness. If the witness fails to recall what occurred at the well site, payment of the invoice may be delayed even further.

Moreover, a variety of complicating issues may further delay the company's payment of the invoice. For example, several owners may share the ownership of the well; several different independent contractors may service the well; and invoices may cover a wide assortment of goods and services, such as consumable materials, non-consumable parts, direct labor, subcontracted labor, and equipment rental. Sorting through the various issues can take a lot of time.

Consequently, suppliers may experience significant delays in receiving payments for their products and services. Such delays may not only create cash flow problems for the supplier, but they may also breed a supplier's contempt for the well owner. As for the well owners, the time spent “shuffling papers” and settling questions about an invoice can be costly. Moreover, a long delay between receiving an invoice and when the actual goods or services were provided may raise a well owner's suspicion of their suppliers.

### SUMMARY OF THE INVENTION

To avoid the problem and limitations of current methods of managing billing information, it is an object of the invention to create invoice data directly at a well site.

A second object of the invention is to have a service vehicle transport a computer to a well site and have a contractor of the service vehicle enter invoice data into the computer, wherein the primary purpose of the service vehicle is to facilitate performing a service operation at the well site.

A third object is to communicate the invoice data from the computer at the well site to another computer at a remote home base location where an oil company can review the invoice data.

A fourth object is to use a wireless communication link to communicate invoice data between a computer at a well site and another computer at a remote location relative to the well site.

A fifth object is to display on the computer at the well site information that indicates invoice data has been made available to another computer, and/or a well company has no immediate objection to the invoice data.

A sixth object is to authorize a contractor to enter, send, or receive invoice-related information by requiring the contractor to enter a password.

A seventh object to approve invoice data by having a company representative enter a password into a computer upon witnessing goods or services provided by a contractor.

An eighth object is to substantiate invoice data with data created from an electrical signal that a transducer generates upon sensing a delivery, part or service operation.

A ninth object is to use a computer at a well site to collect invoice data from more than one independent contractor doing different service operations or providing different goods.

A tenth object of the invention is to collect invoice data of different service operations, such as manipulating sucker rods, manipulating tubing, pumping a fluid (e.g., acid or cement), or downhole logging.

These and other objects of the invention are provided by a method of managing billing information that involves transporting a computer to a well site, providing a wireless communication link between a home base computer and the one at the well site, entering invoice data from more than one independent contractor into the computer at the well site, and communicating the data to the home base computer.

### BRIEF DESCRIPTION OF THE DRAWINGS

FIG. 1 is a schematic diagram illustrating a method of managing billing information according to a currently preferred embodiment of the invention.

### DESCRIPTION OF THE PREFERRED EMBODIMENT

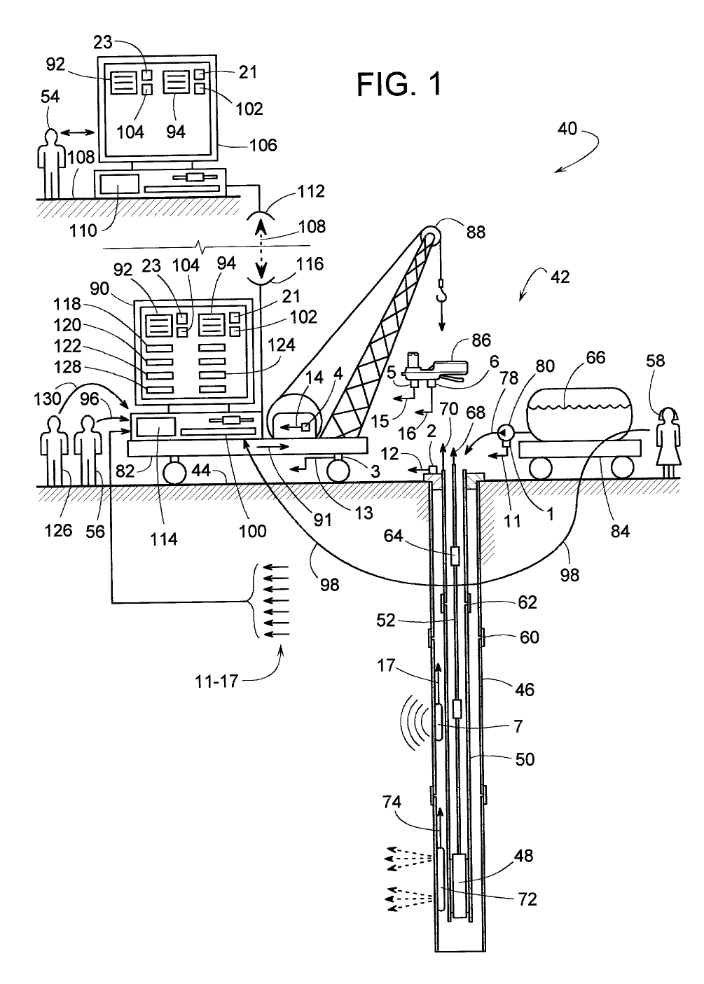

FIG. 1 illustrates a method 40 of managing billing information pertaining to goods and services associated with a well 42 at a well site 44. The term, “billing information” refers to a price or cost for the well-related goods or services. The term, “goods and services” refers to any item or process used in servicing a well.

Well 42 is schematically illustrated to encompass any apparatus for drawing a fluid (e.g., oil, gas, water, etc.) from the ground. In some embodiments of the invention, well 42 includes a string of outer piping known as casing 46. When perforated, casing 46 provides a conduit that conveys fluid from within the ground to the inlet of a submerged reciprocating pump 48. An inner string of pipe, known as tubing 50, provides a discharge conduit that conveys the fluid from the outlet of pump 48 to the surface. A powered pivoting beam (not shown) moves a string of sucker rods 52 up and down, which in turn moves the pump's piston up and down to pump the fluid.

To service or maintain well 42, an oil company 54 (e.g., well owner, operator, or representative thereof) hires one or more contractors 56 and 58 to provide the necessary goods and services. Examples of common parts that contractors 56 or 58 may replace at well site 42 include, but are not limited to, casing 46; tubing 50; sucker rods 52; pump 48 or its components, such as seals and valves; casing couplings 60; tubing couplings 62; sucker rod couplings 64; packer glands; and various parts associated with the pivoting beam, such as its drive motor. Examples of various consumable and non-consumable fluids 66 that may be added to the well bore include, but are not limited to hot oil, acid, or cement. Examples of common services operations that contractors 56 or 58 may perform at well site 44 include, but are not limited to, delivering parts; manipulating sucker rods (e.g., installing, torquing, or replacing rods 52, as indicated by arrow 68); manipulating tubing (e.g., installing, torquing, or replacing tubing 50, as indicated by arrow 70); perforating casing 46, as indicated by a perforating gun 72 suspended from a cable or wireline 74; down hole logging, as indicated by a transducer 7 also suspended from a wireline; pumping fluid 66 (e.g., cement, acid, hot oil, etc.) into well 42, as indicated by pump 78 and arrow 80; welding; fracture treatments; drilling; stimulating; swabbing; bailing; testing; providing rental equipment; and various other work that is familiar to those skilled in the art. The list of possible goods (e.g., consumable and non-consumable parts and fluids) and services could be considered endless, as new components and services are continually being developed.

To provide the various goods and services, contractors 56 and 58 preferably use a service vehicle. The term, “service vehicle” refers to any vehicle used to facilitate delivering parts and/or performing one or more service operations on well 42. Examples of a service vehicle include, but are not limited to, mobile work-over unit 82 and a tanker 84. Work-over unit 82 includes a variety of equipment including, but not limited to, tongs 86 (e.g., rod tongs or tubing tongs), and a wireline winch and/or a hoist 88. Work-over unit 82 is particularly suited for removing and installing well components, such as sucker rods, tubing, etc.; lowering instruments into the well bore via a cable or wireline; and may even be used in actually drilling the well bore itself. Tanker 84 is schematically illustrated to encompass all other types of service vehicles including, but not limited to, pumping vehicles, such as a chemical tank truck or trailer, a cement truck or trailer, and a hot-oiler tank truck or trailer.

One of the service vehicles, such as vehicle 82, also transports a computer 90 to well site 94, as depicted by arrow 91. The term, “computer” used herein and below refers to any device for storing and/or possessing digital information. Examples of a computer include, but are not limited to, personal computers, PC, desktop computer, laptop, notebook, PLC (programmable logic controller), data logger, etc. Computer 90 with common software (e.g., Microsoft Word, Excel, Access; Visual Basic; C++; etc.) allows contractor 56 to enter invoice data 92 that pertains to goods or services provided by contractor 56 with the assistance of vehicle 82. Computer 90 also allows contractor 58 to enter invoice data 94 that pertains to goods or services provided by contractor 58 with the assistance of vehicle 82. The steps of entering data 92 and 94 are schematically represented by arrows 96 and 98 respectively, and can be accomplished manually by using a keyboard 100 or can be entered in some other conventional manner, such as scanning a bar code label or sensing a radio frequency identification device. Invoice data refers to any information commonly associated with a bill for goods or services. Invoice data 92 and 94 may include information such as part numbers, price, quantities, descriptions, labor fees, rental costs, taxes, miscellaneous charges, or other invoice related information. Invoice data 92 can be an entire invoice or just one line item of an invoice having several line items.

To help support the validity of invoice data 92 and 94, computer 90 can be provided with electrical signals from one or more transducers that monitor various activities at the well. For example, when pumping fluid 66 (e.g., hot oil, chemical, acid, gas, water, steam, cement, etc.) a transducer 1 can generate an electrical signal 11 in response to monitoring things such as the fluid's volume or mass flow rate, pressure, temperature, acidity, or concentration. A conventional A/D converter associated with or incorporated within computer 90 converts electrical signal 11 (or any other electrical signal) to a digital value 21. Value 21 and perhaps a time stamp 102 (indicating the date or time of day that transducer 1 was operating) can then be stored on computer 90. An internal clock of computer 90 can provide time stamp 102. Value 21 could then help validate an invoice charge for fluid 66. Likewise, various other transducers for measuring other service operations can be used to validate other invoice data.

In some service operations, such as the removal and replacement of sucker rods 52, packer glands, tubing 50, etc., a transducer 2 (e.g., a proximity switch) could determine whether parts are being removed or installed. When replacing sucker rods 52 or other well components, a transducer 3 could monitor the load on hoist 88 by sensing the force or weight being carried by vehicle 82. Transducer 3 in conjunction with a transducer 4 for monitoring a hoist engine speed could monitor the force and horsepower required to pull rods 52 or tubing 50 from the well bore. An electrical signal 13 from transducer 3 could be converted to a digital value 23 and stored on computer 90 to help validate invoice data 92. For tongs 86, which are powered by a hydraulic system on vehicle 82, transducer 5 can be used to monitor or control the tong's hydraulic pressure or torque. Another transducer 6 can be used to monitor or control the tong's rotational speed. Transducer 7 can indicate the density of the ground surrounding casing 46 or can indicate the integrity or wall thickness of casing 14. The term, “transducer” refers to any device that provides an electrical signal in response to sensing a condition or status of a service operation. Examples of a transducer include, but are not limited to, a pressure switch, a strain gage, a temperature sensor, a flow meter, a tachometer, a limit switch, a proximity switch, etc. For the embodiment of FIG. 1, transducers 1, 2, 3, 4, 5, 6 and 7 respectively provide electrical signals 11, 12, 13, 14, 15, 16 and 17, with digital values 21 and 23 being based on signals 11 and 13 respectively.

Invoice data 92 and 94, and optional supporting information (e.g., values 23, 21, time stamp 102, and another time stamp 104 associated with transducer 3) can be communicated to another computer 106 at a remote location 108, such as a home base from which company 54 operates. The term, “remote location” refers to a location that is beyond the immediate property or land on which well 42 is contained or one mile away from well 42, whichever is greater. Data 92 and 94, values 23 and 21, and time stamps 104 and 102 can be communicated from computer 90 to computer 106 through a wireless communication link 108. The term “wireless communication link” refers to data being transmitted over a certain distance, wherein over that certain distance the data is transmitted through a medium of air and/or space rather than wires. Wireless communication link 108 is schematically illustrated to represent a wide variety of systems that are well known to those skilled in the art of wireless communication. For example, with a modem 110 and an antenna 112 associated with computer 106, and another modem 114 and an antenna 116 for computer 90, data 92 and 94 can be exchanged between computers 90 and 106 using the Internet and any one of a variety of common formats including, but not limited to, HTML, e-mail, etc.

Once data 92 and 94 are made available to computer 106, information 118 to that affect could be displayed on computer 90. One example of information 118 would be a statement such as, “Data 92 has been successfully submitted.” A confirmation 120 could also be displayed on computer 90 to inform contractors 56 and 58 that company 54 currently has no objection to invoice data 92 or 94. One example of confirmation 120 could be a statement, such as, “Thank you—Your invoice will be processed shortly.”

To expedite the process of approving invoices submitted by contractors, company 54 may provide contractors 56 and 58 with confidential alphanumeric passwords 122 and 124, respectively. Passwords 122 and 124 can be randomly generated by computer 4, or can be generated by computer 4 and communicated to computer 4 over communication link 4. Passwords 122 and 124 can be used in different ways.

For example, in some forms of the invention, entering such a password into computer 90 would serve as a prerequisite for entering data 92 and 94 and/or for displaying confirmation information 120.

In another version of the invention, a representative 126 of company 54 can be at well site 42 to witness or confirm that contractors 56 and/or 58 have actually provided their goods and services. Company 54 can then immediately, but tentatively, approve invoices by having representative 126 enter (indicated by arrow 130) a confidential alphanumeric password 128 into computer 90. Password 128 would indicate that representative 126 has witnessed or approved the supplied goods and services. If contractors 56 and 58 mail their invoices to company 54, then including password 122 or 124 along with the written invoices would inform company 54 that representative 126 has already given his or her approval, thus reducing the time for processing the invoices. In this example, passwords 122 and 124 have been generated as a random number in response to representative 126 entering into computer 90 approval information in the form of password 128. Password 122 or 124 being included along with an invoice submitted to company 54 would mean that company 54 (or its representative) has already approved particular goods and/or services provided by a certain contractor for a particular well on a certain date and within a certain price range. By using passwords 122 and 124 in this manner, company 54 does not have to waste time investigating the accuracy or validity of submitted invoices. After the invoices have been submitted to company 54 or after company 54 processes the invoices, passwords 122 and 124 expire, thus preventing those passwords from being misapplied to other invoices.

It should be noted that method 40 is particularly useful when contractors 56 and 58 are independent contractors, and vehicles 82 and 84 each assist in performing a different service operation. The term, “independent contractors” refers to contractors that are not employees of company 54, wherein each contractor has their own employees.

Although the invention is described with reference to a preferred embodiment, it should be appreciated by those skilled in the art that various modifications are well within the scope of the invention. Therefore, the scope of the invention is to be determined by reference to the claims that follow.

I claim:

1. A method of managing billing information of a first contractor and a second contractor doing work for a company, wherein the first contractor is doing a first service operation at the well site, the second contactor is doing a second service operation at the well site, and the company has a first computer at a remote location relative to the well site, comprising:
transporting a second computer to the well site;
providing a wireless communication link between the first computer and the second computer;
using a first vehicle to facilitate the first contractor doing the first service operation;
using a second vehicle to facilitate the second contractor doing the second service operation;
inputting into the second computer first invoice data pertaining to the first service operation;
inputting into the second computer second invoice data pertaining to the second service operation; and
communicating the first invoice data and the second invoice data from the second computer to the first computer using the wireless communication link.

2. The method of claim 1, wherein the first vehicle is used in transporting the second computer to the well site.

3. The method of claim 1, further comprising displaying confirmation information on the second computer that indicates that the company has not objected to the first invoice data.

4. The method of claim 3, further comprising entering into the second computer a first alphanumeric password that serves as a prerequisite for displaying the confirmation information.

5. The method of claim 1, further comprising displaying on the second computer information that indicates that the first invoice data and the second invoice data has been made available to the first computer.

6. The method of claim 1, further comprising: generating a first electrical signal from a first transducer associated with the first vehicle; converting the first electrical signal to a first digital value; storing the first digital value on the second computer; and using the first digital value to support the validity of the first invoice data.

7. The method of claim 6, further comprising: generating a second electrical signal from a second transducer associated with the second vehicle; converting the second electrical signal to a second digital value; storing the second digital value on the second computer; and using the second digital value to support the validity of the second invoice data.

8. The method of claim 1, wherein the first service operation involves manipulating at least one of a plurality of sucker rods and a plurality of tubing.

9. The method of claim 1, wherein the second service operation involves pumping a fluid.

10. The method of claim 9, wherein the fluid is an acid.

11. The method of claim 9, wherein the fluid includes cement.

12. The method of claim 1, wherein the second service operation involves downhole logging, and the second vehicle assists the second contractor in doing the second service operation by transporting a logging transducer to the well site.

13. The method of claim 1, wherein the first invoice data includes a plurality of line items, which are selectively classifiable as consumable, nonconsumable, labor, and rental.

14. The method of claim 1, further comprising entering a well site identifier into the second computer.

15. A method of managing billing information of a first contractor doing work for a company, wherein the first contractor is doing a first service operation at the well site, and the company has a home base computer at a remote location relative to the well site, comprising:
transporting a mobile computer to the well site;
using a first vehicle to assist the first contractor in doing the first service operation;
confirming that the first contractor has performed the first service operation;
entering into the mobile computer approval information that indicates that the step of confirming has been carried out;
displaying on the mobile computer a password of a limited useful life in response to entering the approval information into the second computer;
with the aide of the password, submitting to the company first invoice data that pertains to the first service operation; and
terminating the limited useful life of the password after submitting the first invoice data to the company.

16. The method of claim 15, further comprising approving the first invoice data based on the existence of the password.

17. The method of claim 15, further comprising:
providing a wireless communication link between the home base computer and the mobile computer; and
communicating the approval information from the mobile computer to the home base computer using the wireless communication link.

18. A method of managing billing information of a first contractor and a second contractor doing work for a company, wherein the first contractor is doing a first service operation at the well site, the second contactor is doing a second service operation at the well site, and the company has a first computer at a remote location relative to the well site, comprising:
using a first vehicle to assist the first contractor in doing the first service operation;
using a second vehicle to assist the second contractor in doing the second service operation;
using the first vehicle to transport a second computer to the well site;
providing a wireless communication link between the first computer and the second computer;
inputting into the second computer first invoice data pertaining to the first service operation;
inputting into the second computer second invoice data pertaining to the second service operation;
communicating the first invoice data and the second invoice data from the second computer to the first computer using the wireless communication link;
displaying on the second computer information that indicates that the first invoice data and the second invoice data has been made available to the first computer;
displaying confirmation information on the second computer that indicates that the company has not objected to the first invoice data; and
entering into the second computer a first alphanumeric password that serves as a prerequisite for displaying the confirmation information.

19. The method of claim 18, further comprising: generating a first electrical signal from a first transducer associated with the first vehicle; converting the first electrical signal to a first digital value; storing the first digital value on the second computer; and using the first digital value to support the validity of the first invoice data.

20. The method of claim 18, wherein the first service operation involves manipulating at least one of a plurality of sucker rods and a plurality of tubing.

21. The method of claim 18, wherein the second service operation involves pumping a fluid.
